(19) United States
(12) Patent Application Publication
(10) Pub. No.: US 2012/0084601 A1
(43) Pub. Date: Apr. 5, 2012

(54) COMPUTER SYSTEM RESCUE METHOD

(76) Inventors: YUNG-CHIH LEE, Keelung City (TW); Yen-Huang Cheng, Xindian City (TW)

(21) Appl. No.: 12/894,146

(22) Filed: Sep. 30, 2010

(51) Int. Cl. G06F 11/07

(52) U.S. Cl. 714/15; 714/E11.023

(57) ABSTRACT

A computer system rescue method uses the AMtek iTablet Recovery to diagnose, unfold, restore an operating system with a Windows Pre-install Environment (WinPE) component and back up or recover an operating system or data with a Windows APIs image component. Firstly, in the low-level disk formatting, a disk area is selectively partitioned into three primary sectors and n logical partitions, or is unconfigured for installation of Linux. After installing the Windows system and the operating system used by the user in one primary sector, the AMtek iTablet Recovery is particularly installed in another sector or a mass storage device such as a plug-and-play portable hard drive, and then all the old data of the user is moved to the Windows.old directory through the AMtek iTablet Recovery, thus separating the booting system from the operating system, in which manner, when the computer of the user is infected with a virus, the operating system is unstable or the computer fails to boot normally, the AMtek iTablet Recovery can reinstall or recover the operating system.

### BACKGROUND OF THE INVENTION

(a) Technical Field of the Invention

The present invention relates to a computer system rescue method capable of separating the booting system from the operating system, which, when the computer of the user is infected with a virus, the operating system is unstable or the computer fails to boot normally, can reinstall or recover the operating system with the recovery of my desktop.

(b) Description of the Prior Art

Conventional recovery systems for rescuing a computer, such as “Symantec Ghost”, “Cyberlink Power Recovery”, and “Windows Recovery Environment (WinRE)”, are illustrated as follows:

Current recovery manner 1: “Symantec Ghost”

Compressed file format: *.gho

Boot mode: supporting MS-DOS, PC-DOS, and Windows

Pre-install Environment (32 bit)

Technical Differences:

1. To maintain the file content, it needs decompression and recompression or entering the operating system for alternation.

2. One file has one operating system.

3. Different manufacturers have different file formats and different compression methods, and thus the compatibility is not good and the mutual access cannot be realized.

4. The recovery will definitely clear all the old data of the user.

5. Activating the recovery or reinstallation can be done without need of the Out-Of-Body-Experience (OOBE) program.

Current recovery manner 2: Cyberlink Power Recovery

Compressed file format: *.wsi

Boot mode: supporting the Windows Pre-backfill Environment (32 bit, 64 bit)

Technical Differences:

1. To maintain the file content, it needs decompression and recompression or entering the operating system for alternation.

2. One file has one operating system.

3. Different manufacturers have different file formats and different compression methods, and thus the compatibility is not good and the mutual access cannot be realized.

4. The recovery will definitely destroy all the old data of the user.

5. Activating the Advanced Recovery function or activating the Windows Recovery Environment (WinRE) is not supported. When the control panel of Windows 7 activates the Advanced Recovery function or activates the Windows Recovery Environment (WinRE) to restore your computer, the Master Boot Record (MBR) is cleared due to the recovery of the computer, and the one-key recovery function originally in the MBR fails to work, as shown in FIG. 1A.

6. The one-key recovery function for booting only displays the specified key of indication.

7. The backup and recovery of the booting system and the operating system must be carried out together. If the Bitlocker function of Windows 7 is used, the fabricated operating system is inevitably separated from the booting system, and thus the booting system will not be backed up, and only the operating system is recovered during the recovery but the booting system cannot be recovered, as shown in FIG. 1B. In this case, if the booting system of the user is infected with a virus or is destroyed, the computer will fail to boot.

8. The user can only choose to clear all the old data of the user and recover the original factory setting, as shown in FIG. 1C.

9. Activating the recovery or reinstallation can be done without need of Out-Of-Body-Experience (OOBE) program.

Current recovery manner 3: Windows Recovery Environment (WinRE)

Compressed file format: *.wim ImageX (Microsoft library)

Boot mode: supporting WinPE (32 bit, 64 bit)

Technical differences: Windows Recovery Environment (WinRE) activates F8 to restore your computer or the Advanced Recovery of the control panel needs to be activated through the OOBE, so the OOBE can activate F8 to restore your computer or the Advanced Recovery function of the control panel only after the user sets the initial basic settings and enters the desktop.

Since the conventional computer rescue and recovery systems have the aforementioned defects, the present invention is dedicated to finding the improvements, and after the strenuous process of invention, the present invention is created.

### SUMMARY OF THE INVENTION

The computer system rescue method of the present invention uses the AMtek iTablet Recovery to diagnose, unfold, restore Windows operating system with a Windows Pre-install Environment component and back up or recover the operating system or data with a Windows APIs image component.

The full name of WinPE is the Window Pre-install Environment component, as shown in FIG. 2, which is used for the diagnose, unfold, and restore operations of Microsoft Windows. It is a system capable of booting Windows components for executing the future diagnose, unfold, and restore operations of Microsoft Windows in the situation that no multimedia is installed.

WinPE authorizes the Independent Software Vendors (ISVs) and the Original Equipment Manufacturers (OEMs), with an aim to establish customized unfolding and diagnosis and effectively restore the Windows system. This aim is also applicable to WinPE2.0 which has basic components of Windows Vista® operating system, including 32-bit x86 and 64-bit x64 versions. The 32-bit version Windows must install and use the 32-bit version, and likewise the 64-bit version Windows must install and use the 64-bit version. However, the 64-bit version Windows PE 2.0 does not support WOW64, so the 64-bit version can execute only the 64-bit use and driving device.

To sum up, WinPE is a bootstrap device having a core function which is sufficient for diagnosing, unfolding and restoring. It is capable of booting and executing without installation or online connection, and can be booted and executed from a network with PXE (Preboot Execute Environment), a single CD/DVD, a USB Flash Device (UFD) or a hard drive.

The Windows APIs image component mainly aims to spontaneously execute a program to capture, modify and apply a writing or metadata image of the operating system. ImageX is a supply tool in the Image APIs. The Windows APIs image can be used to back up or recover the operating system or data, and the Windows APIs image is a Windows image format (Windows image (.wim)) for Windows® 7 and describes a management method for instructing the spontaneous program. The Windows image format (Windows image (.wim)) is a basic image format incorporated into Windows Vista®. The .WIM files are compressed packages containing a number of related files. The .WIM format using LZX compression will bring about a lot of compression benefits as expected optimistically. Fast compression needs to use XPRESS, or no compression is used.

A WIM file structure contains up to six types of resources: header, file resource, metadata resource, lookup table, XML data, and integrity table. FIG. 3 illustrates the general layout of a WIM file containing two images.

Based on the above, the recovery method of the present invention is: AMtek iTablet Recovery having the following features:

Compressed file format: *.wim ImageX (Microsoft library)

Boot mode: supporting WinPE (32 bit, 64 bit)

Technical Differences:

1. Support the file format of Windows Imageing File Format (WIM) and have the function of adding and deleting the driver or other language kits, and can send an instruction in an off-line manner to install, remove, set, and add functions and kits of the file without entering the operating system for installation.

2. For the same wim file, more than one operating system can be placed.

3. Allow decompressing, modifying and then recompressing.

4. When using the AMtek iTablet Recovery, the disk is divided into three primary disk partitions and n logical partitions, or its unconfigured disk partition is used for installing Linux.

5. Independent booting system: since the booting system and the operating system are separated, if a serious damage like the booting or MBR damage or malicious modification induced by a virus occurs, the booting data can be reestablished and the specified key activates the recovery function to restore the original functions of the system, regardless of recovery or reinstallation.

6. Support activating the Advanced Recovery function or activating the Windows RE. When the control panel of Windows 7 activates the Advanced Recovery function or activates Windows RE to restore your computer, the one-key recovery function originally in the Master Boot Record (MBR) can still be reestablished even if the MBR is restored to the initial value of Windows MBR due to the recovery of the computer.
Reestablishing method: After Windows recovers the computer and before the computer reboots, the Windows recovers the MBR to the initial value, and after restoring the initial value of MBR, AMtek iTablet Recovery backfills an instruction code of the MBR one-key recovery function key in the disk area of total 440 bytes with an address from the 0th byte of the 0th sector of the 0th track to the 439th byte of the 0th sector of the 0th track of the hard drive.

7. In addition to displaying a specified key of indication, the one-key recovery function key of the booting AMtek iTablet Recovery is provided with a time indication function, which enables the user to know the time left for pressing down a countdown mechanism of the function, and when the time is up, the control right is returned to the operating system.
A so-called quick clearance mechanism is provided, which enables directly exiting the one-key recovery function of the AMtek iTablet Recovery and entering the operating system within the indicated time by pressing the ESC or Enter key if no waiting is desired.

Also, a postponed clearance mechanism is provided, i.e., pressing and holding the left Ctrl or right Ctrl key as the computer is booting to activate the postponed clearance for extending the countdown seconds, so as to ensure that the user has more time to activate the specified key to activate the AMtek iTablet Recovery when intending to use the recovery.

8. Only the backup of the operating system is required. The AMtek iTablet Recovery can help the user to establish the booting system (this function is provided only in Windows 7).

9. Activating the recovery or reinstallation can be done without need of the Out-Of-Body-Experience (OOBE) program.

10. The user can choose to reinstall or clear all the old data of the user and recover the original factory setting, and currently, the reinstallation function is provided only in Windows XP.

The detailed construction, application priciples, functions and efficacy of the present invention may be apparent with reference to the following descriptions in accordance with the drawings.

### BRIEF DESCRIPTION OF THE DRAWINGS

FIG. 1A is a block diagram illustrating a failure of the one-key recovery function originally in the MBR when Windows 7 activates the Advanced Recovery according to a conventional computer rescue and recovery system;

FIG. 1B is a block diagram illustrating a conventional computer rescue and recovery system which recovers the operating system only but cannot recover the booting system when Windows 7 restores;

FIG. 1C is a block diagram illustrating a conventional computer rescue and recovery system which can only choose to clear all the old data of the user and recover the original factory setting when Windows 7 restores;

FIG. 2 is a structural block diagram of a WinPE component applied in the computer system rescue method of the present invention;

FIG. 3 is a general layout view of a Windows APIs image component containing two .WIM image files applied in the computer system rescue method of the present invention;

FIG. 4 is a flow chart 1 of the computer system rescue method of the present invention;

FIG. 5 is a flow chart 2 of the computer system rescue method of the present invention;

FIG. 6 illustrates a function key prompt picture presented after the computer reboots abnormally according to the computer system rescue method of the present invention;

FIG. 7A illustrates a picture of choosing to recover the file or reinstall Windows presented on the computer following FIG. 6;

FIG. 7B illustrates a picture of confirming whether to execute the deletion of all the data in the partition C of the operating system presented on the computer following FIG. 7A;

FIG. 7C illustrates a picture of confirming whether to move the data to Windows.old and execute the reinstallation of Windows presented on the computer following FIG. 7B;

FIG. 7D illustrating a picture of starting to execute an action till the action is completed and choosing to restart or shut down presented on the computer following FIG. 7C;

FIG. 8 is a block diagram of reinstalling Windows XP when the computer system rescue method of the present invention is activated;

FIG. 9A is a block diagram of reinstalling Windows XP operating system without Windows Recovery Environment (WinRE) when the computer system rescue method of the present invention is activated;

FIG. 9B is a block diagram of Windows 7 executing the directory in partition C to reestablish the booting system when the computer system rescue method of the present invention is activated;

FIG. 10A is a picture 1 for the factory to deploy AMtek iTablet Recovery;

FIG. 10B is a picture 2 for the factory to deploy AMtek iTablet Recovery;

FIG. 11A is a block diagram for the factory to deploy AMtek iTablet Recovery in Windows 7 environment;

FIG. 11B is a block diagram for the factory to deploy AMtek iTablet Recovery in Windows XP environment; and

FIG. 12 is a flow chart 3 of the computer system rescue method of the present invention.

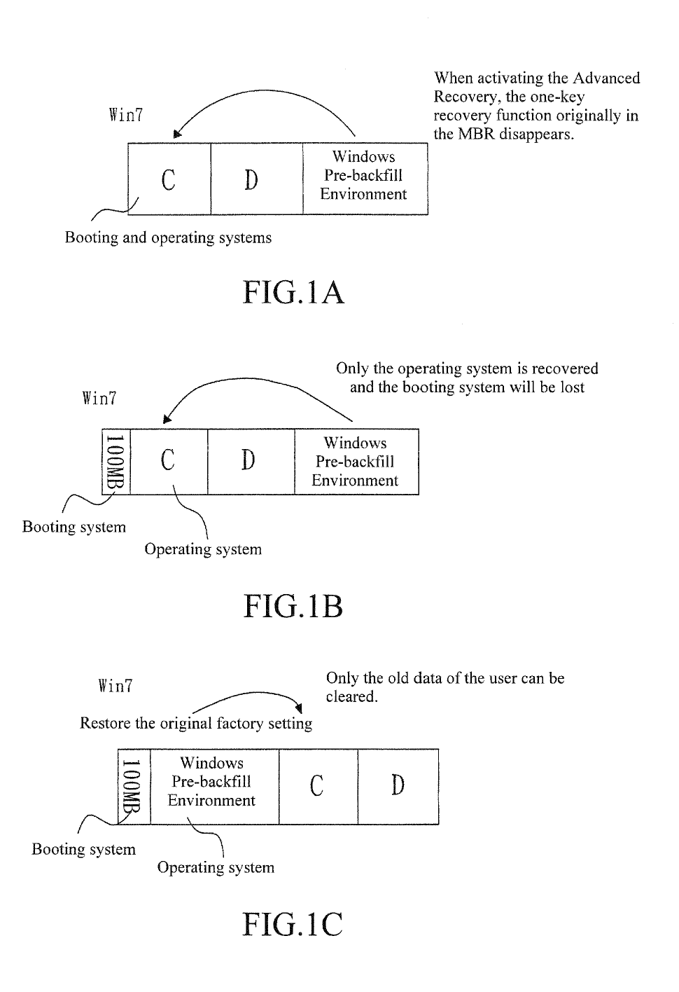

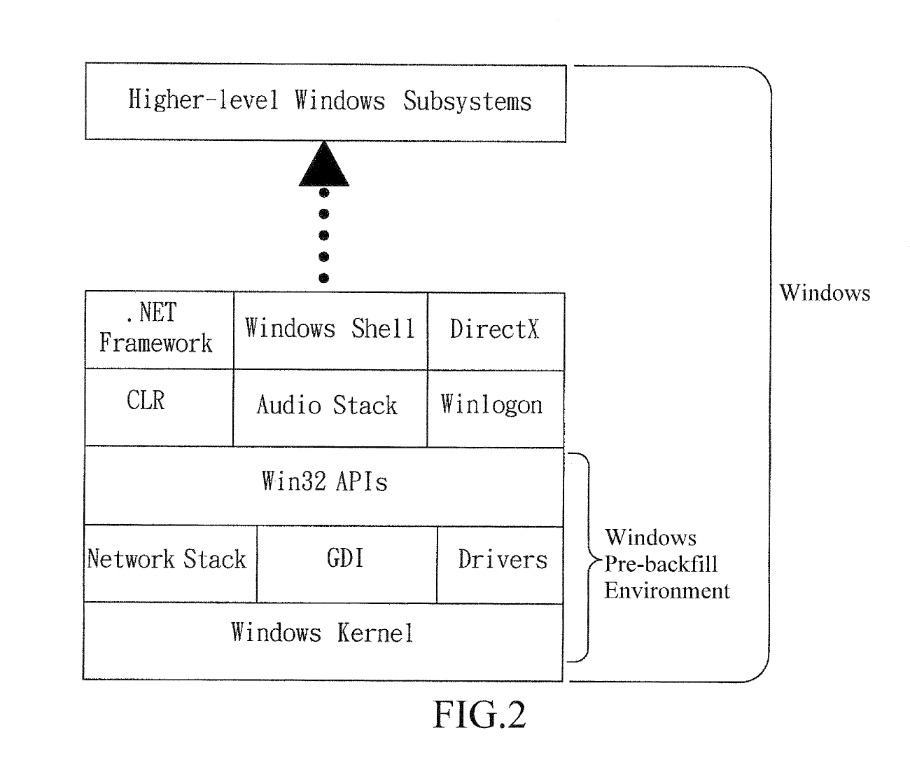

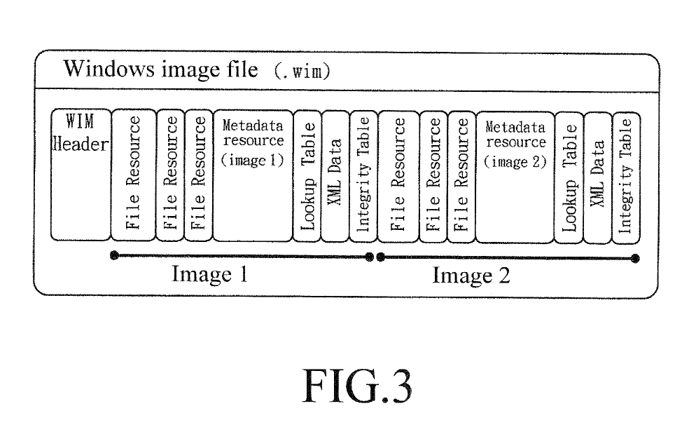

### DETAILED DESCRIPTION OF THE PREFERRED EMBODIMENTS

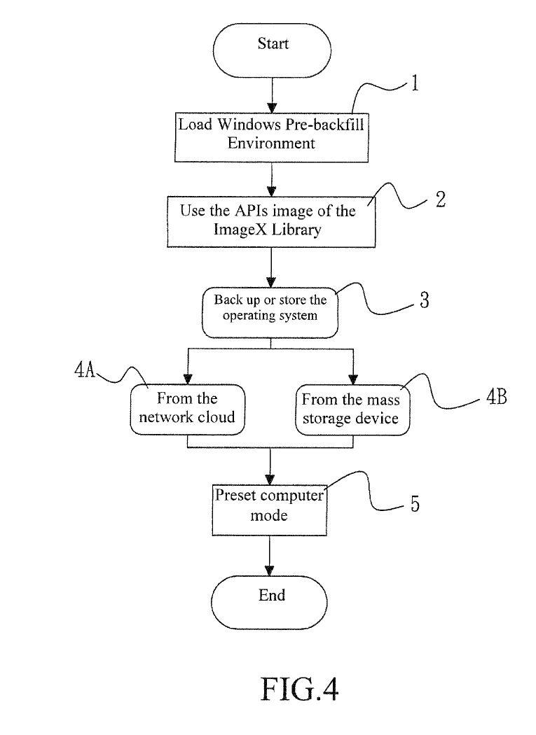

FIG. 4 is a flow chart 1 of the computer system rescue method of the present invention. As shown in this figure, WinPE can be used for booting and the Imaging APIs is used for Windows backup, storing initial data from the network or mass storage device, and recovering to the target computer.

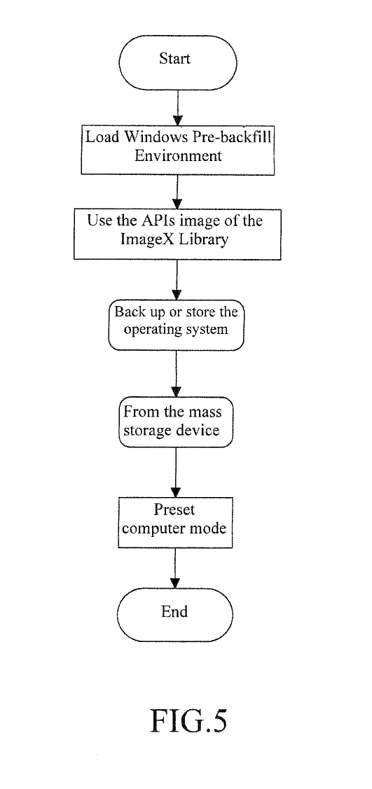

After booting, firstly, in Step 1, WinPE automatically boots to enter Step 2: use the ImageX Library-Imaging APIs to enter Step 3: back up or restore the operating system; in Step 4A of Step 4: from the network, or Step 4B of Step 4: use the mass storage device to perform Step 5 to finish the predefined target computer. However, in consideration of providing convenience for the user, the manufacturer builds the AMtek iTablet Recovery in the mass storage device when producing. According to the flow chart 2 of FIG. 5, the dependence on the network in Step 4A of Step 4 as shown in the preceding figure is not required, and thus the trouble of getting familiar with network operations can be avoided for the user.

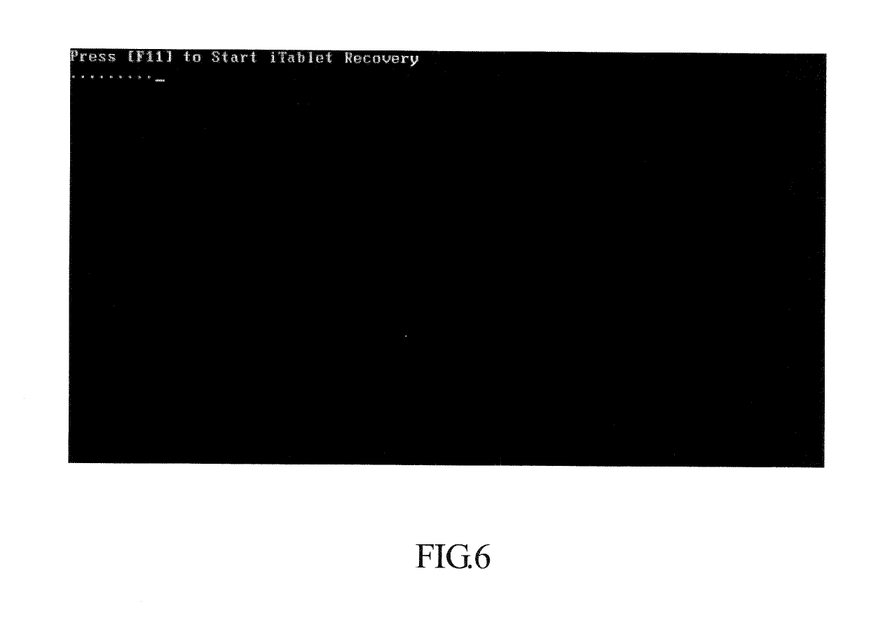

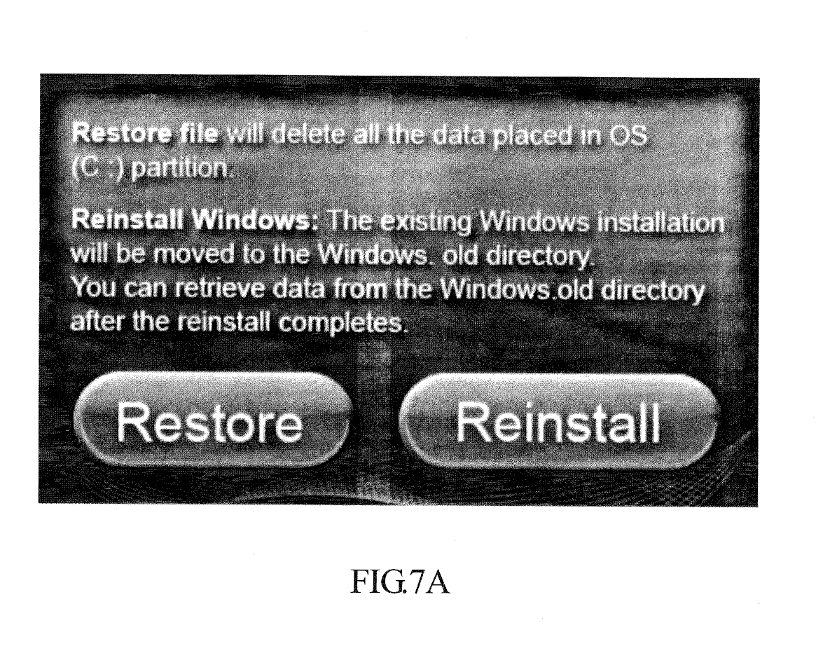

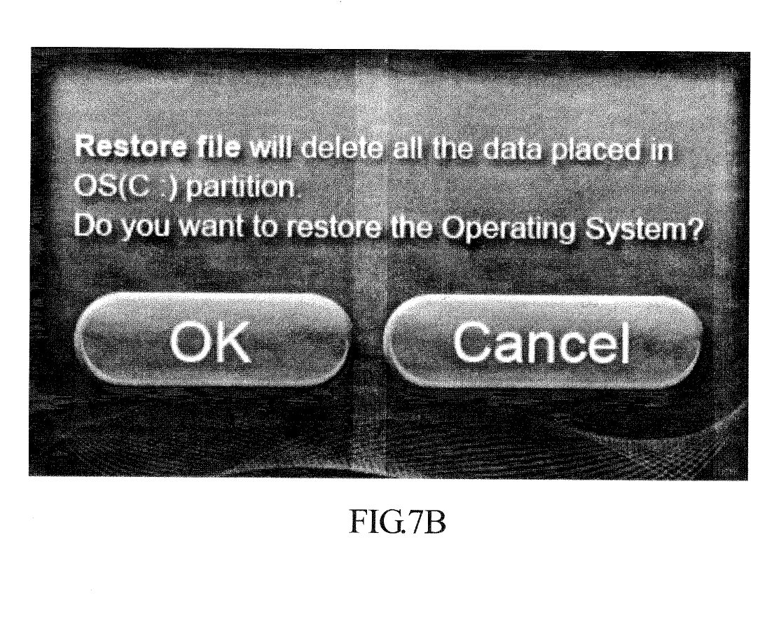

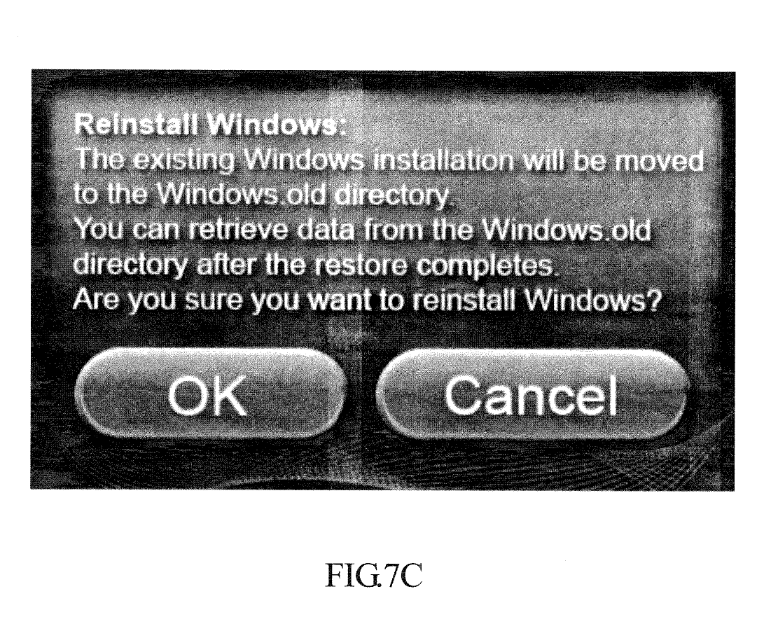

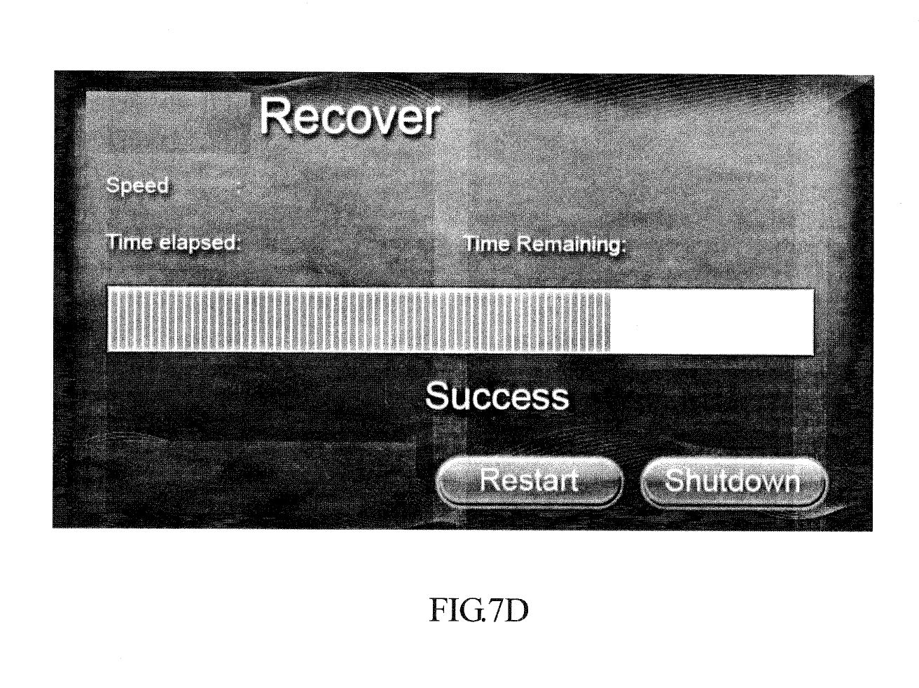

When the computer of the user is infected with a virus, the operating system is unstable or the computer fails to boot normally, the user can reboot. After booting, the prompt picture of the function key specified in FIG. 6 (specified as F11 in this figure) appears to ask the operator to activate the AMtek iTablet Recovery in the mass storage device (e.g. a hard drive). In the case of Windows XP, the operation prompts presented on the computer screen are the picture of choosing to recover the file or reinstall Windows in FIG. 7A, the picture of confirming whether to execute the deletion of all data in the partition C of the operating system in FIG. 7B, the picture of confirming whether to move the data to Windows.old and execute the reinstallation of Windows in FIG. 7C, and the picture of starting to execute an action till the action is completed and choosing to restart or shut down in FIG. 7D, and these pictures can be used for selecting the recovery or reinstallation operation. However, in the case of Windows 7, after pressing the specified function key, the pictures of operation presented on the screen are shown in FIG. 7C and FIG. 7D, and such pictures can be selected only for the recovery of the operating system to finish the recovery; the activating mode of the function key is written in the Master Boot Record (MBR) of the mass storage device (e.g. hard drive), and the AMtek iTablet Recovery is activated by a prewritten MBR software program.

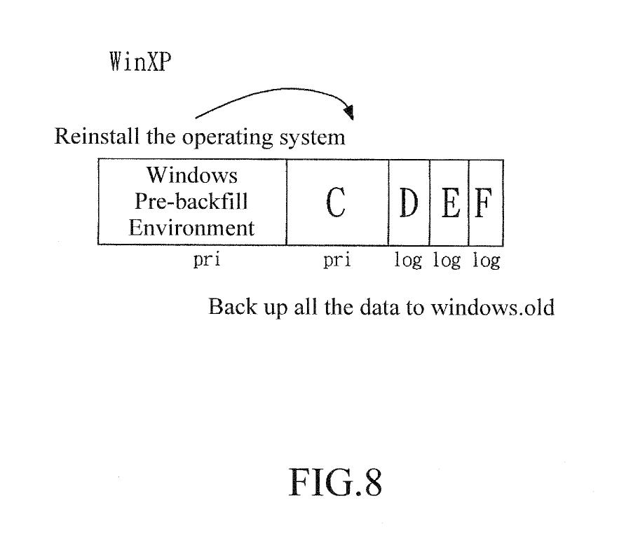

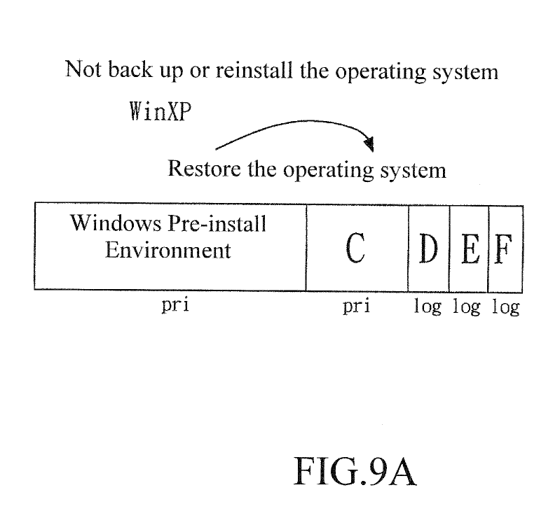

For the reinstallation of Windows XP, as shown in the block diagram of FIG. 8, the MBR activates the function key (the specified key designated to be F11 as shown in FIG. 6), i.e., one-key recovery function key (the specified key), to activate WinPE, so as to boot through the WinPE, and by simulating the reinstallation function of WinRE (because the operating system of XP does not have WinRE), move all the old data of the OS partition C to Windows.old and recover the original factory setting, and then decompress the install.wim file in WinPE to the OS partition C, thereby achieving the purpose of backfilling the operating system.

Regarding the recovery function that can be used by both Windows XP and Windows 7, it means to clear all the old data and the partitions of the hard drive of the user's operating system and recover the original factory setting to reestablish the operating system, i.e., selecting the recovery means to activate WinPE, clear all the data in the OS partition C, and decompress the install.wim in the WinRE to partition C, so as to achieve the purpose of recovering the operating system.

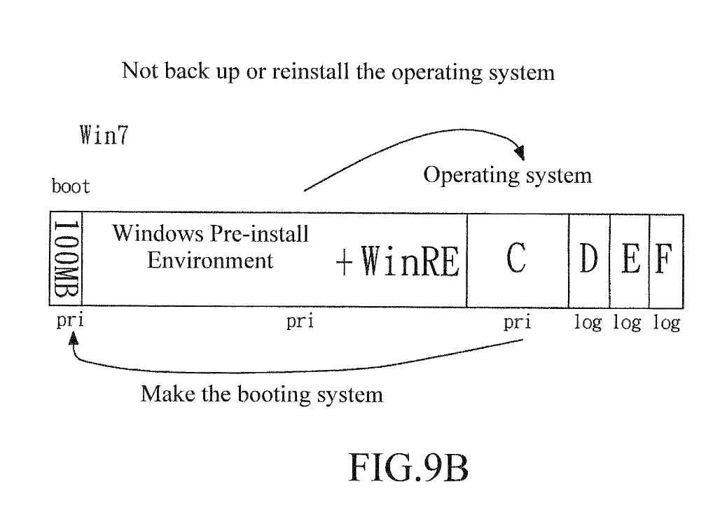

Therefore, although the Windows XP operating system does not have WinRE, it is not required to additionally execute C:\Windows\system32\bcdboot.exe to reestablish booting, as shown in FIG. 9A; for Windows 7: the directory in partition C C:\Windows\system32\bcdboot.exe c:\Windows needs to be executed to reestablish the booting system, as shown in FIG. 9B.

In the hard drive recovery manner provided by a manufacturer for the use convenience of the user, the AMtek iTablet Recovery is built in the user's hard drive, wherein, although it occupies the space of the hard drive, once the computer is infected with a virus or fails to boot and thus needs to return to the factory setting, the user can press only the function key to return to the initial factory value without asking others for help, regardless of the computer techniques of the user, and the operation procedure is very convenient. Also, for manufacturing in the factory, one-key recovery enables clearing the test program environment and recovering to the initial factory settings, which, compared with the manner of deploying the network server, is simple and convenient in recovering the factory setting environment. Further, the user does not need to prepare a disk or disk driver to recover the operating system, which is more convenient for a computer system without any disk driver, and the computer system manufacturer does not need to manufacture a recovery CD, thus reducing the cost and stress of the CD inventory.

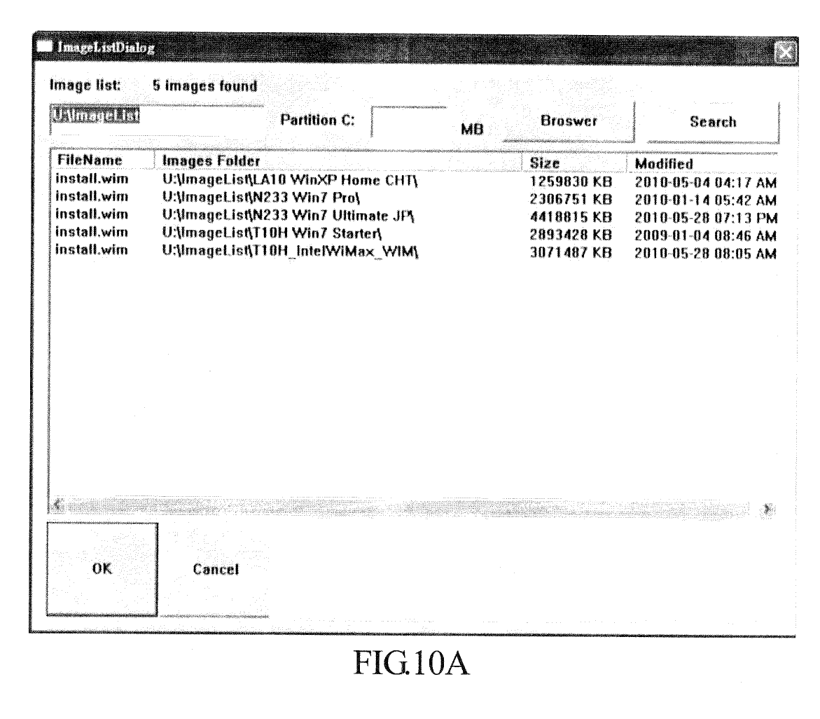

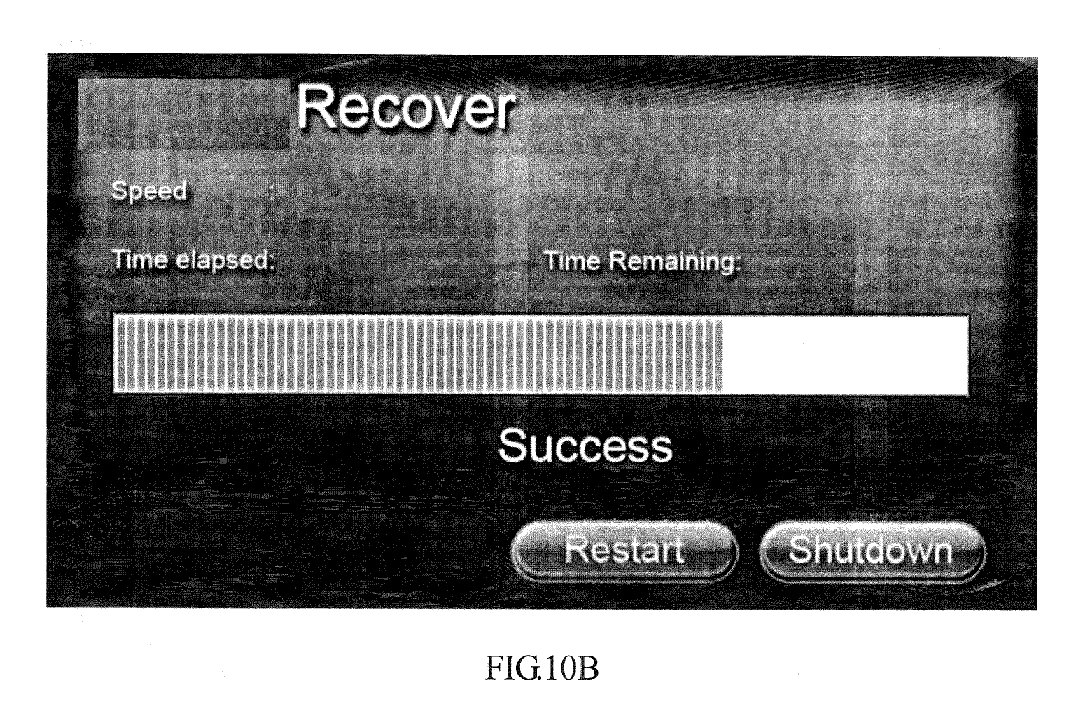

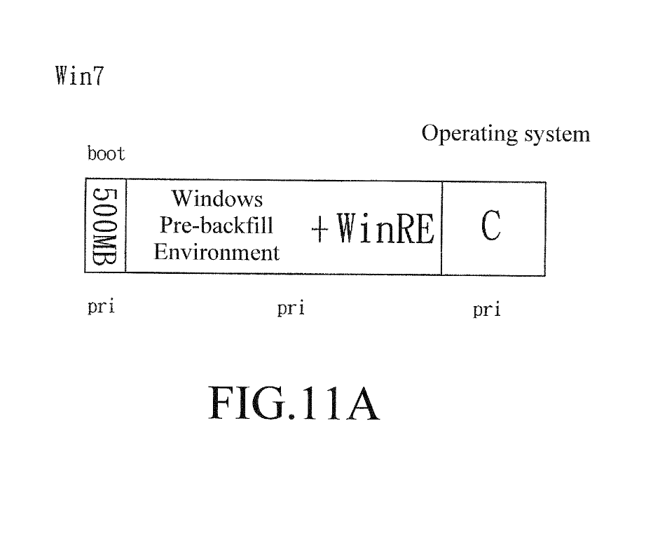

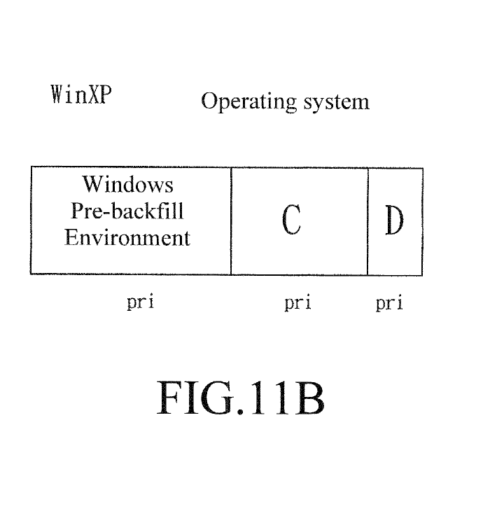

In the input manner for the supply manufacturer to deploy the AMtek iTablet Recovery, executing the DeployWindows.exe, specifying the selected ImageX, and then pressing OK can start deploying the AMtek iTablet Recovery and factory preset operating system (as shown in FIG. 10A). After the program execution ends, the auto shut down occurs to finish the deployment (as shown in FIG. 10B), and the block diagram of deploying Windows 7 is shown in FIG. 11A, wherein the internal execution instructions of DeployWindows.exe and the programs of confighd.txt and configHD2.txt are listed as follows:

DeployWindows7.cmd
@echo off
diskpart /s configHD.txt
imagex /apply install.wim 1 c:
c:\window\system32\bcdboot.exe c:\window
md R:\Recovery\WindowsRE
copy install .wim R:\Recovery\WindowsRE
xcopy Y:\WinPE\*.* /s /e /f r:\
Copy Y:\WinRE.wim R:\Recovery\WindowsRE
C:\window\System32\Reagentc.exe /setreimage /path R:\Recovery\
WinRE /target C:\Windows
C:\window\System32\Reagentc.exe /setosimage /path
R:\Recovery\ WinRE /target C:\ Windows
diskpart /s configHD2.txt
SETMBRwin7.EXE
shutdown -s -t 5
confighd.txt
select disk 0
clean
create partition primary size=500
select partition 1
active
format fs=ntfs label=”System”quick
create partition primary size=6000
select partition 2
format fs=ntfs label=”Recovery” quick
assign letter = R
set ID=27 NOERR OVERRIDE
create partition primary
select partition 3
format fs=ntfs label=”OS” quick
assign letter = C
exit
configHD2.txt
select disk 0
select partition 2 NOERR OVERRIDE
set ID=27 NOERR OVERRIDE
exit

The deployment of Windows XP differs from that of Windows 7 in terms that XP does not have built-in disk partition software, so one more disk partition is divided for the user. The block diagram of deploying Windows XP is shown in FIG. 11B, wherein the programs of Deploy windows XP-1.cmd, confighdxp.txt, final.cmd and final.txt are listed as follows:

Deploy windowXP-1.cmd
del setdisksuccess.txt
diskpart /s configHDXP.txt
md R:\Recovery\WinRE
confighdxp.txt
select disk 0
clean
create partition primary size=3000
select partition 1
format fs=ntfs label Recovery quick
assign letter = R
create partition primary size=40000
select partition 2
format fs=ntfs label OS quick
active
assign letter = C
create partition primary
select partition 3
format fs=ntfs label=”DATA” quick
assign letter = D
exit
final.cmd
del finalsuccess.txt
diskpart /s final.txt
setmbrxp.exe
final.txt
sel disk 0
sel part 2
active
rescan
exit

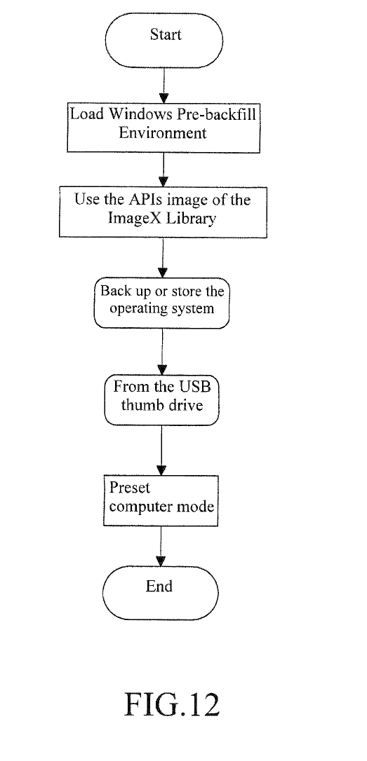

Additionally, the mass storage device for installing the AMtek iTablet Recovery may be a USB thumb drive in addition to a hard drive. The AMtek iTablet Recovery is embedded into the USB thumb drive, so that the USB thumb drive has the ImageX's backup and recover function and thus can easily backup and recover (plug and recover) the operating system. Likewise, when the computer is infected with a virus, the operating system is unstable or the computer fails to boot normally, the Windows Backfill Environment is used for booting, calls the Imaging APIs for Windows, and backs up or recovers files from the cloud or mass storage device to the target computer. Since the carrier of the AMtek iTablet Recovery may be a USB thumb drive or PXE server which activates the AMtek iTablet Recovery to back up or recover files from the cloud or mass storage device to the target computer, in the aspect of manufacturing products, the USB thumb drive with the AMtek iTablet Recovery embedded therein may be manufactured into products for sale. The number of the USB thumb drives is not large in the situation of using the PXE server to enter the AMtek iTablet Recovery, and only the network cable and PXE server are required, which is applicable to large-scale deployment. However, the PXE server and the network environment must be established, which has difficulty in establishment and low portability and mobility. If the USB thumb drive is used to install the AMtek iTablet Recovery, which is more advantageous than the disk with the retention period of about 3-5 years and solves the problems of ease to scratch, long burning time and long time for making backup existing in a disc, and is also more advantageous than an external hard drive. The external hard drive is liable to have the problems of low battery and requiring for an external USB power source. Moreover, the PXE server is not required to be additionally established, and only the USB thumb drive needs to be prepared for the AMtek iTablet Recovery, thereby providing high portability and flexibility. However, this manner is not applicable to large-scale deployment, which requires plenty of USB thumb drives, and has an establishment cost much higher than the network deployment, so this manner is only applicable to small-scale deployment. In the aspects of manufacturing products and providing convenience for the user in use, the carrier of the AMtek iTablet Recovery is the USB thumb drive, and the AMtek iTablet Recovery is activated to directly recover files from the USB thumb drive itself to the target computer (as shown in the flow chart of FIG. 12), wherein the advantages are listed as follows:

1. No cloud servers or additional external storage devices are required to be established, and the recovery file is stored in the USB thumb drive.

2. The interface is extremely simple and easy to use, and the backup file will not occupy the user's computer, which is the most convenient for keeping files.

3. When the user replaces the original hard drive with a brand new hard drive, the operating system and data can be easily recovered.

4. During backup, the position of the operating system is actively detected and recorded, which enables recovering the original position of the operating system during recovery.

5. It is different from the manner of using a hard drive to install the AMtek iTablet Recovery, in which both backup and recovery require specifying the position of the hard drive partition.

6. Files are backed up in the USB thumb drive, no backup files are stored on the hard drive or disk, and the problems of the retention period of disk and space occupation of the hard drive are solved. Therefore, as long as the USB thumb drive is not lost, the backup may be kept for a long time.

In view of the above, the computer system rescue method of the present invention really enables separating the booting system from the operating system, so when the computer of the user is infected with a virus, the operating system is unstable or the computer fails to boot normally, the AMtek iTablet Recovery is used to reinstall or recover the operating system, which overcomes the defects in the prior art and has not been disclosed. Therefore, the present invention comforms to the specification of the Patent Law, and we hope it will be granted with the patent rights.

It should be stated that only the preferred embodiments of the present invention are described in the above and that the alternations or functions made without departing from the concept of the present invention and spirit covered by the specification and figures should fall within the scope of the present invention.

I claim:

1. A computer system rescue method, using an AMtek iTablet Recovery to diagnose, unfold, restore Windows operating system with a Window Pre-install Environment (WinPE) component, and back up or recover the operating system or data with a Windows APIs image component, which is characterized in:
firstly, in a low-level disk formatting, selectively partitioning a disk area into several sectors, after installing the Windows system and the operating system used by the user in a primary sector, particularly installing the AMtek iTablet Recovery in another sector, and then moving all old data of the user to a Windows.old directory through the AMtek iTablet Recovery, thus separating the booting system from the operating system, in which manner, when the computer of the user is infected with a virus, the operating system is unstable or the computer fails to boot nomally, the AMtek iTablet Recovery can reinstall or recover the operating system.

2. The computer system rescue method according to claim 1, wherein in the low-level disk formatting, selectively partitioning a disk area into several sectors comprises partitioning the disk area into three primary sectors and n logical partitions.

3. The computer system rescue method according to claim 1, wherein in the low-level disk formatting, selectively partitioning a disk area into several sectors comprises unconfiguring the disk area for installation of a Linux system.

4. A computer system rescue method, using an AMtek iTablet Recovery to diagnose, unfold, restore Windows operating system with a Window Pre-install Environment (WinPE) component, and back up or recover the operating system or data with a Windows APIs image component, which is characterized in:
firstly, in a low-level disk formatting, selectively partitioning a disk area into several sectors, after installing the Windows system and the operating system used by the user in a primary sector, particularly installing the AMtek iTablet Recovery in a plug-and-play USB thumb drive, and then moving all old data of the user to a Windows.old directory through the AMtek iTablet Recovery, thus separating the booting system from the operating system, in which manner, when the computer of the user is infected with a virus, the operating system is unstable or the computer fails to boot normally, the AMtek iTablet Recovery can reinstall or recover the operating system.

5. A computer system rescue method, using an AMtek iTablet Recovery to diagnose, unfold, restore Windows operating system with a Window Pre-install Environment (WinPE) component, and back up or recover the operating system or data with a Windows APIs image component, which is characterized in:
firstly, in the low-level disk formatting, selectively partitioning a disk area into several sectors, after installing the Windows system and the operating system used by the user in a primary sector, connecting the AMtek iTablet Recovery from a network, and then moving all old data of the user to a Windows.old directory through the AMtek iTablet Recovery, thus separating the booting system from the operating system, in which manner, when the computer of the user is infected with a virus, the operating system is unstable or the computer fails to boot normally, the AMtek iTablet Recovery can reinstall or recover the operating system.

6. The computer system rescue method according to claim 1, wherein:
before the AMtek iTablet Recovery restores the Windows operating system and particularly recovers the operating system and reboots, Windows recovers a Master Boot Record to an initial value incidentally, and after restoring the initial value of the Master Boot Record, the AMtek iTablet Recovery backfills an instruction code of an one-key recovery function key of the Master Boot Record in the disk area of total 440 bytes with an address from the 0th byte of the 0th sector of the 0th track to the 439th byte of the 0th sector of the 0th track of the hard drive.

7. The computer system rescue method according to claim 6, wherein, in addition to displaying a specified key of indication, the one-key recovery function key of the AMtek iTablet Recovery is provided with a time indication function which enables the user to know the time left for pressing down a countdown mechanism of the function, and when the time is up, the control right is returned to the operating system.

8. The computer system rescue method according to claim 7, wherein the time indication function of the one-key recovery function key is set to enable directly exiting the one-key recovery function of the AMtek iTablet Recovery and quickly clearing to enter the operating system within the indicated time by pressing a particular key if no waiting is desired.

9. The computer system rescue method according to claim 8, wherein the particular key is ESC key.

10. The computer system rescue method according to claim 8, wherein the particular key is Enter key.

11. The computer system rescue method according to claim 7, wherein:
restoring the Windows operating system through the AMtek iTablet Recovery particularly has a postponed clearance mechanism, and after recovering the operating system and rebooting, the postponed clearance can be activated by pressing any Ctrl key, thus extending the countdown seconds.

12. The computer system rescue method according to claim 4, wherein:
by restoring the Windows operating system through the AMtek iTablet Recovery, particularly after recovering the operating system and before rebooting, Windows recovers the Master Boot Record back to the initial value incidentally, and after restoring the initial value of the Master Boot Record, the AMtek iTablet Recovery backfills an instruction code of an one-key recovery function key of the Master Boot Record in the disk area of total 440 bytes with an address from the 0th byte of the 0th sector of the 0th track to the 439th byte of the 0th sector of the 0th track of the hard drive.

13. The computer system rescue method according to claim 12, wherein, in addition to displaying a specified key of indication, the one-key recovery function key of the AMtek iTablet Recovery is provided with a time indication function which enables the user to know the time left for pressing down a countdown mechanism of the function, and when the time is up, the control right is returned to the operating system.

14. The computer system rescue method according to claim 13, wherein the time indication function of the one-key recovery function key is set to enable directly exiting the one-key recovery function of the AMtek iTablet Recovery and quickly clearing to enter the operating system within the indicated time by pressing a particular key if no waiting is desired.

15. The computer system rescue method according to claim 14, wherein the particular key is ESC key.

16. The computer system rescue method according to claim 14, wherein the particular key is Enter key.

17. The computer system rescue method according to claim 13, wherein restoring the Windows operating system through the AMtek iTablet Recovery particularly has a postponed clearance mechanism, and after recovering the operating system and rebooting, the postponed clearance can be activated by pressing any Ctrl key, thus extending the countdown seconds.

18. The computer system rescue method according to claim 5, wherein:
by restoring the Windows operating system through the AMtek iTablet Recovery, particularly after recovering the operating system and before rebooting, Windows recovers the Master Boot Record back to the initial value, and after restoring the initial value of the Master Boot Record, the AMtek iTablet Recovery backfills an instruction code of an one-key recovery function key of the Master Boot Record in the disk area of total 440 bytes with an address from the 0th byte of the 0th sector of the 0th track to the 439th byte of the 0th sector of the 0th track of the hard drive.

19. The computer system rescue method according to claim 18, wherein, in addition to displaying a specified key of indication, the one-key recovery function key of the AMtek iTablet Recovery is provided with a time indication function which enables the user to know the time left for pressing down a countdown mechanism of the function, and when the time is up, the control right is returned to the operating system.

20. The computer system rescue method according to claim 19, wherein the time indication function of the one-key recovery function key is set to enable directly exiting the one-key recovery function of the AMtek iTablet Recovery and quickly clearing to enter the operating system within the indicated time by pressing a particular key if no waiting is desired.

21. The computer system rescue method according to claim 20, wherein the particular key is ESC key.

22. The computer system rescue method according to claim 20, wherein the particular key is Enter key.

23. The computer system rescue method according to claim 19, wherein:
restoring the Windows operating system through the AMtek iTablet Recovery particularly has a postponed clearance mechanism, and after recovering the operating system and rebooting, the postponed clearance can be activated by pressing any Ctrl key, thus extending the countdown seconds.
